(19) United States
(12) Patent Application Publication
(10) Pub. No.: US 2003/0234460 A1
(43) Pub. Date: Dec. 25, 2003

(54) Method of producing antiglare and antireflection film

(75) Inventors: Tadashi Hayashi, Minami-Ashigara-Shi (JP); Shinji Hikita, Minami-Ashigara-Shi (JP)

Correspondence Address: YOUNG & THOMPSON, 745 SOUTH 23RD STREET 2ND FLOOR, ARLINGTON, VA, 22202

(73) Assignee: FUJI PHOTO FILM CO., LTD., MINAMI-ASHIGARA-SHI (JP)

(21) Appl. No.: 10/465,585

(22) Filed: Jun. 20, 2003

(30) Foreign Application Priority Data
Jun. 24, 2002 (JP) 2002-183395

(51) Int. Cl. B29D 11/00

(52) U.S. Cl. 264/2.7

(57) ABSTRACT

An antireflection film having an antireflective layer is embossed with an emboss roller or an emboss plate, to become an antiglare and antireflection film. A surface of each of the emboss roller and the emboss plate has concave-convex which have arithmetic roughness average is in the range of 0.05 μm to 2.00 μm and average period of maximum 50 μm. When the film is embossed, an emboss roller applies to the surface of the film a linear pressure in the range of 500 N/cm to 4000 N/cm, or an emboss plate applies a pressure in the range of 50×10⁵ Pa to 400×10⁵ Pa. The concave-convex of the emboss roller or the emboss plate is formed in a shot blast method in which balls having diameter in the range of 0.1 μm to 50 μm are scattered onto the surface of the antireflection film.

### BACKGROUND OF THE INVENTION

1. Field of the Invention

The present invention relates to a method of producing an antiglare and antireflection film, and particularly to a method of producing an antiglare and antireflection film used in an image display device, such as a liquid crystal display, a plasma display panel and the like.

2. Description Related to the Prior Art

An antireflection film is provided in several sorts of image display devices, such as a liquid crystal display (LCD), a plasma display panel (PDP), an electro luminescence display (ELD), a cathode-ray tube display (CRT) and the like. The antireflection film is used for an eyeglass, a lens incorporated in a camera. Several types of the antireflection films have been proposed. Some of them have a multi-layers structure or a nonuniform layer structure, and are widely used.

In the film base are formed transparent layers of metal oxides on a film base, so as to prevent the reflection in a wide wavelength range of a visible ray. Such transparent layers of metal oxides are usually formed in methods of vapor deposition. As the methods, there are chemical vapor deposition (CVD) and physical vapor deposition (PVD). In the CVD, gas phase reaction of two particles (here described as “A” and “B”; A≠B) of molecular or atom, such as metal halide, reagent gas and the like, is made on a surface of a material which is to be processed. Thus a thin layer is formed of a substance “C” (C≠A, C≠B) while the gas phase reaction follows to the reaction formula: A+B→C. In the PVD, some substances are evaporated, such that a gas thereof in form of molecules or atoms forms a thin layer. The PVD is often made in vacuum deposition method and sputtering method.

In production of the antireflection film, the PVD is often carried out on a film base, while a surface of the film base is provided with concave-convex in accordance with the way of use. In this type of the antireflection film, parallel transmittance becomes lower than in the antireflection film having a smooth surface on which that vapor deposition is performed. As the concave or convex surface scatters the external light to decrease the reflection, the produced antireflection film has antiglare property. Accordingly, such antireflection films improve the display quality of the image display device.

The thin layer of metal oxide, above mentioned, provides the excellent optical property for the antireflection film. However, when the thin layer is formed in the method of vapor deposition, particularly the sputtering method, then the productive efficiency of the antireflection film becomes lower, and therefore it is a demerit for the mass production.

Instead of the methods of vapor deposition, the following publications propose methods of producing the antreflection film by coating a film base with a solution containing inorganic micro particles for forming an antireflective layer: Japanese Patent (JP) No. S60-59250 and the Japanese Patent Laid-Open Publications No. S59-50401, H2-245702, H5-13021, H7-28527, H11-6902. In JP No. S60-59250, a solution is cast on a film base to form an antireflective layer including micro particles of inorganic materials and micro voids. After the solution is dried and forms an antireflective layer on the film base, it is processed in gas activation. Thereby, a gas leaves the coating layer, and the micro voids are formed in the coating layer.

The Publication No. 59-50401 teaches two types of antireflection film. In the first one, an antireflective layer is constructed of a high refractive index layer and a low refractive index layer which are formed on a film base upwardly in this order. In the second one, the antireflective layer further includes a middle refractive index layer between the high refractive index layer and the film base. Note that the low refractive index layer is formed of solution containing polymer or inorganic micro particles.

In order to obtain the same optical properties as this publication, the publication No. H2-245702 teaches an antireflection film which includes an antireflective layer having a low refractive index. In the antireflective layer, at least two types of micro particles (for example, MgF₂ and SiO₂) are mixed. The ratio of mixing these types varies in a thickness direction of the antireflective film. Therefore, the refractive index in the antireflective film varies in the thickness direction.

In this antireflection film, the micro particles are fixed through SiO₂ produced in thermal decomposition of the ethyl silicate. In the thermal decomposition, carbon dioxide and steam are generated from the low refractive index layer through the combustion of the ethyl group. Thereby the micro voids are formed between the micro particles in the low refractive index layer, as shown in FIG. 1 of the publication.

The low refractive index layer is often required to have a predetermined intensity, as it is positioned on a display surface of the image display device or on an outer surface of the lens. However, the antireflection film containing micro voids is less strong than in the antireflection film of the publication No. 2-245702. Further, as the antireflection film is formed of only inorganic materials, it is easily broken although it is hard.

The publication No. H5-13021 teaches the improvement of the antireflection film of the publication No. H2-245702. In the improvement, the micro voids is filled with binder. Further, the publication No. H7-48527 teaches an antireflection film containing binder and inorganic particles of porous silica. In these antireflection films, the micro voids are filled with the binder such that the antireflection film may be stronger. However, when the micro voids are filled with the binder, it becomes harder to decrease the refractive index of the antireflection film enough.

The publication No.11-6902 teaches an antireflection film having as an antireflective layer a low refractive index layer in which at least two particles are piled to form the micro voids. In order to produce the antireflection film, a wet coating is made to form the low refractive index layer and to pile three particles in a thickness direction thereof. The wet coating decreases the producing cost for the antireflection film, and the low refractive index layer can have both of the high strength and low reflexive index.

Otherwise, not only the wide view angle and the high speed response but also the high definition are required so much to obtain a high image quality. The high definition is realized by decreasing a cell size. In this case, for example, when the cell size is so smaller that the display has at least 133 ppi (pixel/inch), then the light transmits through the antireflection film, and the light perceived by a user has the nonuniform brightness, which cases the dazzling on the display. Therefore, the quality of the antireflection film becomes lower as a product. Accordingly, the antireflection film is required to have an antiglare property for effectively preventing the reflection of backgrounds and the dazzling.

There are some methods for providing the antiglare property for the above antireflection film in which inorganic micro particles are used. For example, in the first method, matching particles are added to the solution for the antireflective layer, so as to form concave-convex on the antireflection film. In the second method is used the film base having concave-convex on a surface thereof, which is coated with the solution containing inorganic micro particles to form the antireflective layer. Thus the antireflection film is obtained. Thereafter, the antireflection film is processed to have the antiglare property. In this case, it is especially preferable to form concave-convex on at least one surface of the film base after forming the antireflective layer.

The publication No. 2000-275401 and 2000-275404 propose improvements of the antireflection films in the publication No. H11-6902. At first, a flat antireflection film is produced, and a surface thereof is embossed to form the concave-convex. However, the embossed antireflection film has the smaller effects in the antireflectivity and antiglare property than the antireflection film produced in the vapor deposition. Namely, all of antiglare property, strength, low reflective index and the preventing of dazzling is not enough satisfied at the same time.

### SUMMARY OF THE INVENTION

An object of the present invention is to provide a method of producing an antiglare and antireflection film from an antireflection film having an antireflective layer.

Another object of the present invention is to provide a method of producing an antiglare and antireflection film, in which all of antiglare property, strength, low reflective index and the preventing of dazzling is enough.

Still another object of the present invention is to provide a method of producing an antiglare and antireflection film which is adequate to use for high definition display.

In order to achieve the object and the other object, an antireflective layer of an antireflection film is embossed with an emboss press member whose surface has concaves or convexes, such that the emboss press member presses the antireflection film to obtain the antiglare and antireflection film. The concaves convexes have arithmetic roughness average in the range of 0.5 μm to 2.00 μm, and an average period of maximum 50 μm. The concaves or convexes are formed in a shot blast method in which balls having diameter in the range of 0.5 μm to 2.00 μm are shot onto the surface of the emboss press member.

The antiglare and antireflection film further includes a transparent base, a primer layer and a hard coat layer. The primer layer, the hard coat layer and the antireflective layer are overlaid on the transparent base.

The emboss press member is an emboss press roller or an emboss press plate. When the emboss press roller is used, the transparent base is transported continuously. When the emboss press plate is used, the transparent base is transported intermittently.

According to the invention, the antiglare and antireflection film has concaves or convexes formed in accordance with the concaves or convexes of the emboss press member. Accordingly, in the method of the present invention, the antiglare and antireflection film is produced easily and has the same effects in the antireflectivity, antiglare property and mass product as an antiglare and antireflection film produced in a method of vapor deposition.

Furthermore, when the antiglare and antireflection film produced in the present invention is used in an image display, then the reflection of external light on a display surface, the reflection of backgrounds and the dazzling are effectively prevented, and high definition display is the same as in the antiglare and antireflection film produced in the vapor deposition.

### BRIEF DESCRIPTION OF THE DRAWINGS

The above objects and advantages of the present invention will become easily understood by one of ordinary skill in the art when the following detailed description would be read in connection with the accompanying drawings:

FIG. 1 is an explanatory view of the first embodiment of the present invention, which illustrates a situation when a antireflection film having an antireflective layer is embossed so as to become an antiglare and antireflection film;

FIG. 2 is an explanatory view of the second embodiment of the present invention, which illustrates a situation when the antireflection film having an antireflective layer is embossed so as to become an antiglare and antireflection film ;

FIG. 3 is an explanatory view illustrating a situation in processing a part used for embossing the antireflection film in FIG. 2;

FIG. 4 is a sectional view of a first embodiment of the antiglare and antireflection film, which is produced in the present invention:

FIG. 5 is a sectional view of a second embodiment of the antiglare and antireflection film, which is produced in the present invention;

FIG. 6 is a sectional view of a third embodiment of the antiglare and antireflection film, which is produced in the present invention.

### PREFERRED EMBODIMENTS OF THE INVENTION

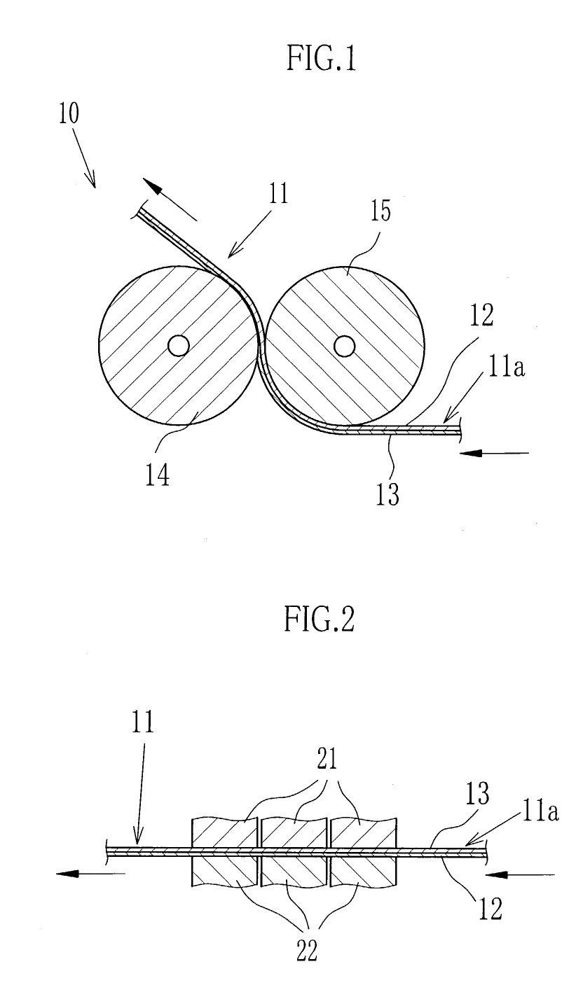

In FIG. 1, an antireflection film 11a having a smooth surface is embossed with an embossing apparatus 10 to become an antiglare and antireflection film 11. The antireflection film 11a (or the antiglare and antireflection film 11) is constructed of a film base 12, and an antireflective layer 13. The antireflective layer 13 is previously formed by coating on the film base 12 at least one solution containing inorganic micro particles. A coating 14 is positioned so as to confront to the antireflective layer 13, and a back-up roller 15 is positioned oppositely to the emboss roller 14, so as to confront to the film base 12. These two rollers press the antireflection film 11a so as to form concaves-convexes on at least one surface of the antireflective layer 13. Thus, the antireflective layer 13 obtains antiglare property without losing antireflectivity, and has a substantially uniform thickness.

The uniformity of the thickness is determined in accordance with number and construction of light interference layers in which light interference is carried out. For example, the light interference layers are a low refractive index layer 44, a high refractive index layer 50 and a middle refractive index layer 55 (see, FIG. 4) in the antireflective layer 13 in the above embodiment, while the low, high and middle refractive index layers 44, 50, 55 are formed in this order from the outside of the antireflection film 11. Each low, high and middle refractive index layer 44, 50, 55 is constructed to have a thickness at nλ/4 (n is a refractive index of the each layer). The thickness of the each layer can fluctuate in range of an average thickness −3% to +3% of the average thickness. When the thickness fluctuates over this range, then the antireflectivity becomes worse.

The antiglare property is controlled by determining of process conditions (such as surface temperature of the antireflection film 11a, pressure, processing speed and the like), physical properties of a transparent base 41 (see FIG. 4) of the antiglare and antireflection film 11, and the like. However, it is preferable that the conditions are determined in view of flatness of the antiglare and antireflection film 11, stability of the processing, cost thereof and the like.

A surface of the emboss roller 14 has concaves-convexes. It is preferable that the concaves-convexes are randomly arranged. Arithmetic roughness average (Ra) of the surface is in the range of 0.05 μm to 2.00 μm, and mean profile peak spacing of concave-convex (RSm) is maximum 50 μm. The Ra is, preferably, in the range of 0.07 μm to 1.50 μm, particularly of 0.09 μm to 1.20 μm, and especially 0.10 μm to 1.00 μm. When the Ra is maximum 0.05 μm, then the antiglare property is not enough. Further, when the Ra is minimum 2.00μm, the resolution becomes lower and the image becomes white in the external light.

The cycle of concave-convex means, for example, the distance between peaks in the nearest protrusions. Namely, the RSm is the average of cycle of concave-conave pattern formed over the surface of the emboss roller 14. When the RSm is larger than 50 μm, then the resolution becomes lower. Further, in this case, a front surface of the antiglare and antireflection film 11 looks like to be rough and the feel of material becomes worse. The RSm is preferably in the range of 5 μm to 30 μm, particularly of 10 μm to 20 μm.

Note that the Ra and the RSm are measured and analyzed with a measuring device of surface roughness on the market. In the above embodiment, SURFTEST SJ-401 (Trade mark, produced by Mitsutoyo Corporation) is used as the measuring device, and the measuring is made on basis of roughness standard of JIS-1994.

The linear pressure of the emboss roller 14 and the back-up roller 15 is preferably in the range of 100 N/cm to 12000 N/cm, particularly of 500 N/cm to 4000 N/cm. Further, a preheat roller (not shown) is disposed upstream from the emboss roller 14 and the back-up roller 15, so as to heat the antireflection film 11a previously to embossing. The temperature of the preheat roller is, preferably, in the range of 60° C. to 180° C. particularly of 70° C. to 160° C.

The emboss roller 14 is connected to a temperature controller (not shown), so as to control the temperature of the emboss roller 14. As the emboss roller 14 is heated, the temperature of the antireflection film 11a can be regulated, preferably in the range of 110° C. to 195° C. The temperature of the emboss roller 14 is preferably in the range of 100° C. to 200° C., particularly of 105° C. to 180° C., and especially of 110° C. to 165° C. Speed of embossing is preferably in the range of 0.3 m/min to 10 m/min, and particularly of 0.5 m/min to 5 m/min.

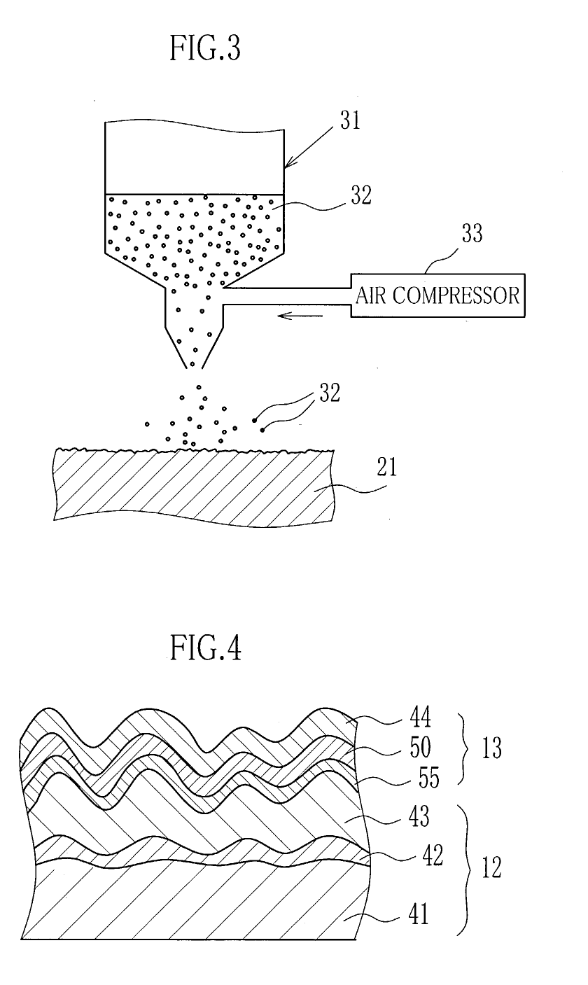

As shown in FIG. 2, the antireflection film 11a may be embossed with three pairs of emboss plates 21 and back-up plates. A surface of each emboss plate 21 is provided with patterns of concave-convex (see FIG. 3). Note that the number and size of the pairs are determined in accordance with size and feeding speed of the antireflection film 11a, scale of the producing plant and the like.

The antireflection film 11a is sandwitched between the emboss plates 21 and the back-up plates 22. Thereby, the emboss plates 21 press the antireflection film 11 in a side of the antireflective layer 13, and the back-up plates 22 receive the antireflection film 11 in a side of the film base 12. Thus the antireflection film 11a is embossed to form concave-convex on a surface of the antireflective layer 13. Note that a preheat roller (not shown) may be disposed upstream from the emboss plate 21, so as to heat the antireflection film 11a previously.

Preferably, the concaves-convexes are formed on a surface of the emboss plates 21, and arranged randomly. The arithmetic roughness average (Ra) of the surface is in the range of 0.05 μm to 2.00 μm, and average period (RSm) is maximum 50 μm. The Ra is preferably in the range of 0.07 μm to 1.50 μm, particularly of 0.09 μm to 1.20 μm, and especially of 0.10 μm and 1.00 μm. The RSm is preferably in the range of 5 μm to 30 μm, particularly of 10 μm to 20 μm.

The pressure of the emboss plate 21 and the back-up plate 22 is preferably in the range of 10×10⁵ Pa to 1200×10⁵ Pa, and particularly of 50×10⁵ Pa to 400×10⁵ Pa. The temperature of the preheat roller is preferably in the range of 60° C. to 180° C., particularly of 70° C. to 160° C.

The emboss plates 21 are connected to a temperature controller for controlling the temperature of the emboss plates 21. The temperature of the emboss plates 21 are preferably in the range of 100° C. to 200° C., particularly of 105° C. to 180° C., and especially of 110° C. to 165° C. Speed of embossing is preferably in the range of 0.3 m/min to 10 m/min, and particularly of 0.5 m/min to 5 m/min.

As shown in FIG. 3, the concave-convex of the emboss plate 21 are formed in a shot blast method. In the shot blast method, a large number of balls 32 collides against the emboss plate 21 by a sand blast 31. The sand blast 31 includes an air compressor 33 for compressing the air, and the compressed air applies a pressure to shot the balls 32. The diameter of the bead is in the range of 0.1 μm to 50.0 μm. Note that the concave-convex on the emboss roller 14 are formed in the same method.

Materials for the surfaces of the emboss plates 21 and the emboss roller 14 may be selected in accordance with materials of the balls 32. Sorts of the materials are not restricted, when the concave-convex is formed so as to satisfy the above conditions of the Pa and the PSm of the emboss plate and the emboss roller. For example, when the balls 32 are formed of glass, it is adequate to plate the surfaces of the emboss plate and the emboss roller with nickel. Further, materials for bases of the emboss plates 21 and the emboss roller 14 may be selected when a thin metal layer is firmly formed on a surface of the base through plating, and when the base has enough endurance to the pressure through embossing. For example, SUS630 is used as the emboss plate 21, and S45C is used as the emboss roller 14.

As shown in FIG. 4, the film base 12 of the antiglare and antireflection film 11 includes the transparent base 41, a primer layer 42, a hard coat layer 43. The primer layer 42 and the hard coat layer 43 are overlaid on the transparent base 41 in this order. The antireflective layer 13 includes the low, high and middle refractive index layers 44, 50, 55 which are formed in this order from an outer side on the hard coat layer. The embossing has the largest influence on the primer layer 42. The primer layer 42 is deformed so as to have a nonuiform thickness, although the hard coat layer 43 and the antireflective layer 13 are bent and the thickness thereof is almost constant. The film base 41 is deformed slightly.

The Publication No. 59-50401 teaches that an optical thickness of each layer in the antireflective layer 13, namely a multiple of refractive index “n” and thickness “d” of each layer, is preferably about nλ/4 or multiples thereof, when “λ” is the design wavelength.

However, in order to realize the reflection properties such as low reflectivity and a decreased color tint of reflection, it is necessary in the present invention that, when the design wavelength λ is 500 nm, then the middle refractive index layer 55 satisfies the formula (I), the high refractive index layer 50 satisfies the formula (II), and the low refractive index layer 44 satisfies the formula (III). Note that the indications “n1, n2, n3” are the respective refractive indexes of the middle, high, and low refractive index layers 55, 50, 44, and that the indications “d1, d2, d3” (nm) are the respective thickness of the middle, high and low refractive index layers 55, 50, 44.

100.00<(n1·d1)<125.00 (I)

187.50<(n2·d2)<237.50 (II)

118.00<(n3·d3)<131.25 (III)

Further, when the transparent base 41 has the refractive index in the range of 1.45 to 1.55, or is made of, for example, triacetyl cellulose (refractive index: 1.49), then “n1” is 1.60-1.65, “n2” is 1.85-1.95, and “n3” is 1.35-1.45. Furthermore, when the transparent base 41 has the refractive index in the range of 1.55 to 1.65, or is made of, for example, polyethylene telephthalate (refractive index: 1.66), then “n1” is 1.65-1.75, “n2” is 1.85-2.05, and “n3” is 1.35-1.45.

Sometimes, it is hard to use materials having the above refractive indexes for the middle and high refractive index layers. As already well know, in this case, plural layers can be formed to construct their combination structure, while each of the plural layers has the higher refractive index and the lower refractive index than the above conditions. The combination structure has effects of an equivalent layer to the middle refractive index layer or the high refractive index layer. Further, the reflective properties can be realized in the combination structure at the same time. Note that the present invention may be provided with the antireflective layer constructed of minimum three plural layers which has effects of the equivalent layer.

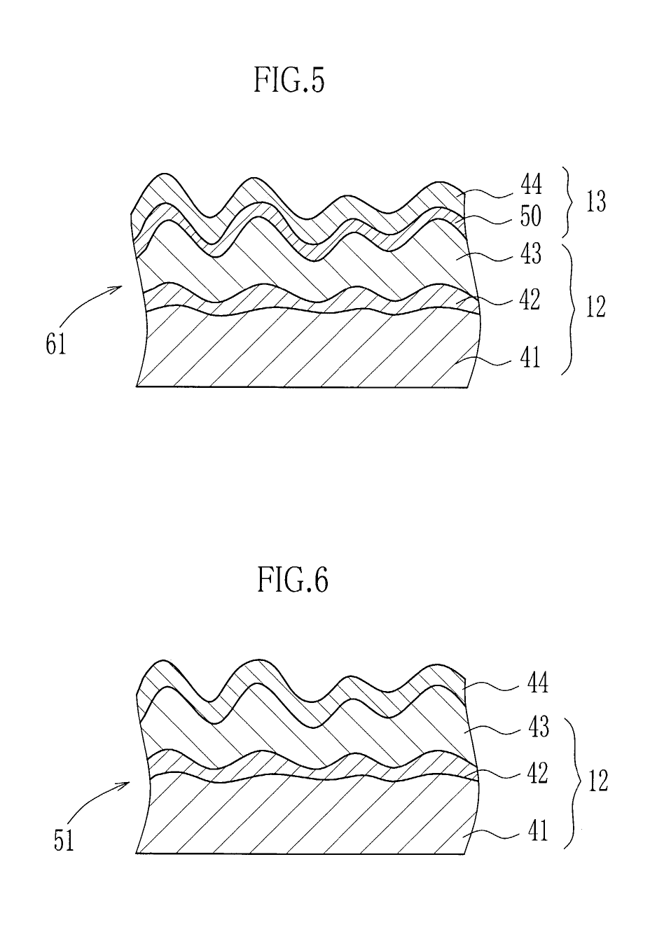

In the present invention, the antireflection film may have different layer-structures in accordance with objects of using. As shown in FIG. 5, the antireflective layer 13 of an antireflection film 51 is constructed of the low and high refractive index layers 44, 50 such that the high refractive index layer is sandwitched between the low refractive index layer 44 and the film base 12. Further, in FIG. 6, the antireflective layer 13 of an antireflection film 61 includes the low refractive index layer 44 only.

In the present invention, it is preferable to use a plastic film as the transparent base. As materials of the plastic film, there are cellulose esters (for example, triacetyl cellulose, diacetyl cellulose, propionyl cellulose, butyril cellulose, acetylpropionyl cellulose, nitro cellulose), poly amide, poly carbonate, poly esters (for example, polyethylene telephthalate, polyethylene naphthalate, poly-1,4-cyclohexane dimethylene telephthalate, polyethylene-1,2-diphenoxyethane-4,4′-dicarboxylate, polybutylene telephthalate), polystyrenes (for example, syndiocactic polystyrene), polyelefines (for example, polypropylene, polyethylene, polymethylpentene), polysulfones, polyethersulfones, polyarylate, polyetherimide, polymethylmethacrylate, and polether ketones, and the like.

Especially, the antiglare and antireflection film 11 can be used as a protective film for constructing one surface of a polarizing filter which is provided in a LCD, an organic electro luminescence display and the like. In this case, it is preferable to form the transparent base of triacetyl cellulose. A preferable method of producing the triacetyl collulose is taught in the publication 2001-1745. Further, when the antiglare and antireflection film 11 is overlapped on a glass plate so as to use for the flat CRT and the PDP, then it is preferable to form the antiglare and antireflection film 11 of polyethylene telephthalate or polyethylene naphthalate.

Permeability of the transparent base 41 is preferably minimum 80%, particularly minimum 86%. A haze of the transparent base 41 is maximum 2.0%, particularly maximum 1.0%. The refractive index of the transparent base 41 has the refractive index in the range of 1.4 to 1.7.

In order to form the middle and high refractive index layers 55 and 50, a mixture is used, which is composed of the inorganic micro particles having high refractive index, thermoset monomers, monomers curable with ionizing radiation, initiator and solvent. The mixture is cast and dried on the film base 12, and thereafter cured with at least one of heating and ionizing radiation such that the middle and high refractive index layers 55 and 50 may be formed. As the inorganic micro particles, it is preferable to use at least one of the oxide of metals, Ti, Zr, In, Zn, Sn, Sb. The middle and high refractive index layers is more excellent in scratch resistance and adhesion than a polymer layer of high refractive index that is formed by casting and drying a polymer solution. In order to keep a stability of dispersion and strength of a formed layer after curing, it is preferable that the mixture further contains (meta) acrylate dispersant containing anionic group and polyfunctional (meta) acrylate monomer, as described in the Japanese Patent Laid-Open Publication No. 11-153703 and U.S. Pat. No. 6,210,858 B1.

Averaged diameter of inorganic micro particle is preferably in the range of 1 nm to 100 nm, when it is measured with coulter counter method. When it is maximum 1 nm, then specific surface area becomes too large to keep stability of the dispersion. When it is minimum 100 nm, then the difference of the refractive index from the binder causes to scatter the visible ray. Accordingly, it is not preferable. Further, the haze of the high and middle refractive index layers 50 and 55 is preferably maximum 3%, and particularly maximum 1%.

Materials for the low refractive index layer 44 is explained now. The materials are a mixture of acrylic resin or epoxy resin and inorganic materials or micro particle thereof, whose refractive index is low. As the inorganic materials, there are, for example, LiF (refractive index n=1.4), MgF₂ (n=1.4), 3NaF.AIF₃ (n=1.4), AlF₃ (n=1.4), Na₃AlF₆ (n=1.33), SiO₂ (n=1.45) and the like. Further, as the material for the low refractive index layer 44, there are fluorine organic materials and silicone organic materials. In the present invention, compounds containing fluorine are especially preferable, as they are cured with heat or ionizing radiation. Kinetic friction of the materials for the low refractive index layer 44 is preferably in the range of 0.02 to 0.18, particularly of 0.03 to 0.15. When the kinetic friction is too large, the front surface of the antiglare and antireflection film 11 can be rubbed and easily damaged. Contact angle of the materials to pure water is preferably in the range of 90° to 130°, particularly of 100° to 120°. When the contact angle is too small, then the finger print and oil can easily adhere. Therefore, it is hard to keep the antiglare and antireflection film 11 clean. Further, the low refractive index layer may contain fillers, such as silica particles and the like, in order to have larger strength.

The materials containing fluorine are, for example, silane containing perfluoroalkyl group (for example, heptadecafluoro-1,1,2,2-tetrahydrodecyl)triethoxysilane) and the like, and further polymers containing fluorine that are composed of monomer containing fluorine and crosslinkable elements.

As the monomers containing fluorine, for example, there are fluoroolefines (fluoroethylene, vinylidene fluoride, tetrafluoroethylene, hexafluoroethylene, hexafluoropropylene, perfluolo-2,2-dimethyl-1,3-dioxol and the like), partial or complete fluorinated alkylester derivatives of (meta)acrylic acid (Biscoat 6FM (produced by Osaka Organic Chemical Industry Ltd.), M-2020 (produced by Daikin Industries, Ltd.) and the like), complete or partial fluoride vinylether and the like. Preferable are perfluoroolefines. Especially preferable is hexafluolopropyrene in view of refractive index, solubility, transparency, procurability and the like.

The elements for performing curing reaction are obtained by polymerization of monomers. The monomer may have functional group for performing self-curing; for example, glycidyl (meta) acrylate, grycidyl vinylether, and the like. Otherwise, the monomers may have carboxyl group, hydroxyl group, amino group, sulfon group; for example, (meta)acrylic acid, methlol (meta) acrylate, hydroxyalkyl (meta) acrylate, allyl acrylate, hydroxyethyl vinylether, hydroxybutyl vinylether, maleic acid, crotonic acid and the like. Furthermore, the polymerization of the elements is made such that the elements may have the group, such as (meta) acrylloil and the like, for curing reaction. In polymerization, for example, acrylic chloride attacks to hydroxyl group.

Further, monomers containing no fluorine can be polymerized with monomers containing fluorine and the crosslinkable elements in view of solubility into a solvent and transparency of formed layers. The monomers containing no fluorine are, for example, olefins (ethylene, propylene, isoprene, vinylchloride, vinylidene chloride, and the like), ester of acrylic acid (methyl acrylate, ethyl acrylate, 2-methylhexyl acrylate) ester of methacrylic acid (methyl methacrylate, ethyl methacrylate, butyl methacrylate, ethylene gricol dimethacrylate, and the like), styrene derivatives (styrene, divinylbenzene, vinyltoluene, α-methylstyrene, and the like), vinyl ethers (methyl vinylether, ethyl vinylether, cyclohexyl vinylether, and the like), vinylesters (vinyl acetate, vinyl propionate, vinyl cinnamate, and the like), acrylamides (N-tert butyl acrylamide, N-cyclohexyl acrylamide, and the like), methacrylic amides, acrylnitril derivatives and the like. However, the monomers containing no fluorine are not restricted in them.

The publications No. H8-92323, H10-25388, H10-147739, H12-17028 teach that the curing agent may be added to the above polymers. Especially, it is necessary to add the curing agent, when the groups for curing have no properties of self-curing, such as hydroxide group, carboxylic group. As the curing agent, there are polyisocianates, aminoplast, polybasic acid and anhydrine thereof. Otherwise, when the monomer can perform the self-curing, it is not necessary to add the curing agent. However, in this case, the curing agent may be added, such that (meta)acrylate compound, polyfunctional epoxy compounds and the like.

In the method of the present invention, the polymers containing fluorine adequate for the low refractive index layer 44 are random polymer of perfluoroolefine and vinylethers or vinylesters. Preferably, such polymers have the groups having property of cross-linking (groups having a property of radical reactions, such as (meta) acryloil groups and the like, groups having property of ring opening polymerization, such as epoxy group, oxetanyl groups and the like). The polymeric units having the crosslinkable group is contained in the range of 5 mol % to 70 mol % in the total polymeric units, especially of 30 mol % to 60 mol %.

Further, it is preferable the polymer containing fluorine has polysyloxiane structure in order to have stainproofness. The method for constructing the polysiloxane structure is not restricted, and for example, Japanese Patent Laid Open Publications No. H11-189621, H11-228631, 2000-313709 teach that silicone macroazoinitiator is used for the polymer to combine component for polysiloxyane block copolymerization with the polymers. Japanese Patent Laid-Open Publications No. H2-251555 and H2-308806 teach that silicone macromer is used to combine polysiloxane graft polymerization with the polymer. In these cases, the polysiloxane is contained in the range of 0.5 wt. % to 10 wt. % in the polymer, especially of 1 wt. % to 5 wt. %.

In order to have stainproofness, it is preferable to add polysiloxane to the polymer. As the products of polysiloxane in the market, there are, for example, KF-100T, X-22-169AS, KF-102, X-22-37011E, X-22-164B, X-22-5002, X-22-173B, X-22-174D, X-22-167B, X-22-161AS (which are trade marks of Shin-Etsu Chemical Co., Ltd.), AK-5, AK-30, AK-32 (which are trade marks of Toagosei Co., Ltd.), Sila Plane FM0275, Sila Plane FM0721 (which are trade marks of Chisso Corporation), and the like. It is preferable that polysiloxane is contained preferably in the range of 0.5 wt. % to 10 wt. % in entire of the low refractive index layer, especially of 1 wt. % to 5 wt. %.

In the method of the present invention, the low refractive index layer is formed of compounds containing fluorine, for example, TEFRON (R) AF1600 (trade mark, produced by E. I. Du Pont Nemours and Company, Refractive index n=1.30), CYTOP (trade mark, produced by Asahi Glass, Co., LTD., n=1.34), 17FM (trade mark, produced by Mitsubishi Rayon Co., LTD., n=1.35), Opstar JN-7212 (trade mark, produced by JSR Corporation, n=1.40), Opstar JN-7228 (trade mark, produced by JSR Corporation, n=1.42), LR201 (trade mark, produced by Nissan Chemical Industries, Ltd., n=1.38), and the like.

It is preferable to use (metha) acryl type polymers, styrene type polymers, polyesters for the primer layer. In the (metha) acrylic type polymers, there are (metha) acrylic acid, methyl (metha) acrylate, ethyl (metha) acrylate, butyl (metha) acrylate, (metha) allylacrylate, (metha) urethaneacrylate, 2-hydroxy ethyl (metha) acrylate, and the like. Further, in the styrene type polymers, there are styrene, divinylbenzene, vinyl toluene, α-methylstyrene. In the polyesters, there are condensation products of alcohol and carboxylic acid or anhydrine thereof. As the alcohol, there are ethylene glycol, propylene glycol, diethylene glycol, and the like. As the carboxylic acid or anhidryne thereof, there are phthalic acid, phthalic anhydrine, telephthalic acid, maleic acid, maleic anhydrine and the like. note that the usable monomers are not restricted in the above description.

Molecular weight (or polymerization degree) is determined in consideration of glass transition temperature Tg of polymer. The glass transition temperature of the polymer contained in the primer layer and the glass transition temperature of the transparent base are preferably lower than the temperature at which embossing is carried out. The preferable glass transition temperature is in the range of 6020 C. to 130° C. Further, the thickness of the primer layer is preferably of 0.1 μm to 50 μm, especially of 0.1 μm to 20 μm.

The primer layer has higher surface elasticity in a room temperature than the transparent base 41. The surface elasticity of the primer layer 42 is preferably from 3 GPa to 8 GPa, particularly from 4 GPa to 7 GPa. The difference of the surface elasticity between the transparent base 41 and the primer layer 42 is preferably from 0.1 GPa to 5 GPa, particularly from 0.2 GPa to 4 GPa.

In the present invention, the surface elasticity of the primer layer 42 at the embossing temperature is lower than that of the hard coat layer 43 on embossing. The difference of the surface elasticity at the embossing temperature between the primer layer 42 and the hard coat layer 43 is preferably in the range of 0.1 Gpa to 8 Gpa, particularly of 0.5 Gpa to 7.5 Gpa. In the present invention, the primer layer 42 makes brightness unevenness (or glaring) smaller, and the surface hardness larger in the liquid crystal display of super fine mode.

The surface elasticity is measured by a microhardness testing tystem, Fischerscope H100VP-HCU (trade mark, produced by Fischer Instruments K. K.) In order to measure the surface elasticity, a sample in which a layer of 10 μm thickness is formed on a glass plate is prepared and set to the microhardness testing system. The microhardness testing system has a press segment of quadrangular pyramid made of diamond (confront angle of tip thereof is 136°), and the quadrangular pyramid presses to the layer on the glass plate at a depth less than one tenth of the thickness of the layer. When the quadrangular pyramid stops pressing, the pressure and the variation thereafter are obtained and used for calculating the surface elasticity.

The primer layer 42 may contain the above polymers and other polymers or other particles. In the other polymers and other particles, for example, there are gelatin, polyvinylalcohol, polyalginic acid and salt thereof, cellulose esters (such as triacetylcellolose, diacetylcellulose, propionylcellulose, butylilcellulose, acetylpropionylcellulose, nitrocellulose, hydroxyethyl cellulose, hydroxypropyl cellulose), polyether ketones, polyhydric alcohols, silica particles and alumina particles.

Preferably, monomers used for constructing the cross-linking structure have more than two ethylenic unsaturated groups. As such monomers, for example, there are esters of polyhybic alcohol and (metha)acrylic acid (ethylene glycol di(metha)acrylate, 1,4-cyclohexane diacrylate, pentaerythrithol tetra(metha)acrylate, and the like), pentaerythrithol tri(metha)acrylate, trimethylolpropane tri(meta)acrylate, trimethylolethane tri(metha)acrylate, dipentaerythrithol tetra(metha)acrylate, dipentaerythrithol penta(meta)acrylate, pentaerythrithol hexa(metha)acrylate, 1,2,3-cyclohexane tetrametacrylate, polyurethane polyacrylate, polyester polyacrylate, and the like), vinylbenzene and derivatives thereof (1,4-divinylbenzene, 4-vinylbenzoic acid-2-acryloyl ethylester, 1,4,-divinylcyclohexanone, and the like), vinylsulfones (divinylsulfone, and the like), acrylamides (methylenebisacrylamide and the like) and methacrylamide.

Instead of the monomers having more than two ethylenic unsaturated groups, or in addition to them, the cross-linking structure may be constructed by crosslinkable groups. As the crosslinkable groups, there are isocyanate groups, epoxy groups, adilidine groups, oxazoline groups, aldehyde groups, cabonyl groups. Further, there are also monomers for constructing the cross-linking structure, such as hydradine anoacrylate derivatives, melanine, etherized methylol, esters and uretanes. Furthermore, blockisocyanate groups, for example, are decomposed to smaller crosslinkable groups. Note that the crosslinkable groups are not restricted in the above ones, and may be groups which are decompositions of the above ones.

In order to form the primer layer 42, the coating solution is prepared, in which polymerization initiators and at least one of polymers and monomers are dissolved in a solvent. It is preferable that a polymerization reaction (and further cross-linking, if necessary) is made in the solution after applying the solution on the transparent base 41. As the polymerization initiators, there are hydrogen abstraction type (benzophenone type and the like) and a radical cleavage type (acetophenone type, triadine type and the like). Preferably, at least one of these polymerization initiators is added with monomers.

The primer layer 42 has an effect to firmly form other layers on the transparent base 41. In order to increase this effect, it is preferable that the solution for forming the primer layer 42 contains the monomers. The weight ratio of the monomer to the polymer in the solution is, preferably, (polymer:monomer)=(75-25):(25-75), and especially, (polymer:monomer)=(65-35):(35-65).

In the antiglare and antireflection film 11, the hard coat layer 43 has effects to maintain scratch resistance. The hard coat layer 43 further has effects to firmly form layers on the transparent base 41. The hard coat layer 43 is formed of acryl type polymer, urethane type polymers, epoxy type polymers and silica type compounds. Pigments may be added to the coating solution for the hard coat layer 43.

Preferably, the coating solution for the hard coat layer 43 conatins polymers having main chain of saturated hydrocarbons or polyethers, particularly those having main chain of saturated hydrocarbons. Further, it is preferable that the polymers have cross-linking structure, and are obtained through polymerization of monomers having ethylenic unsaturated groups. It is expecially preferable that the monomers have more than two ethylenic unsaturated groups.

As the monomers having more than two ethylenic unsaturated groups, there are esters of polyhydric alcohol and (meta)acrylic acid (for example, ethylene glycol di(meta)acrylate, 1,4-dichlohexan diacrylate, pentaerythrithol tetra(meta)acrylate, pentaerythrithol tri(meta)acrylate, trimethylolpropane tri(meta)acrylate, trimethylolethane tri(meta)acrylate, dipentadrythrithol penta(meta)acrylate, pentaerythrithol hexa(meta)acrylate, 1,2,3-cyclohexane tetrametacrylate, polyurethane polyacrylate, polyester polyacrylate, and the like). Furthermore, there are vinylbenzene and derivatives thereof (1,4-divinylbenzene, 4-vinylbenzoic acid-2-acryloil ethylester, 1,4divinylcyclohexanone and the like), vinylsulfone (divinylsulfone and the like), acrilamide (methylene-bisacrylamide and the like) and metacrylamide.

Instead of or in addition to the monomers having more than two hylenic unsaturated groups, the cross-linking structure may be constructed in a reaction of crosslinkable groups. The crosslinkable groups are, for example, isocyanate groups, epoxy groups, aziridine groups, oxazoline groups, aldehide groups, carbonyl groups, hydrazineanoacrylate derivatives, meranine, etherized methylol, esters and urethane. Furthermore, blockisocyanate groups, for example, are decomposed to smaller crosslinkable groups. Note that the crosslinkable groups are not restricted in the above ones, and may be groups which are decompositions of the above ones.

In order to form the hard coat layer 43, the coating solution is prepared, in which polymerization initiators and at least one of polymers and monomers are dissolved in a solvent. It is preferable that a polymerization reaction (and further cross-linking, if necessary) is made in the solution on the transparent base 41. Preferably, at least one of these polymerization initiators is added with the monomers at the same time. Further, the coating solution for the hard coat layer may contain a small amount of polymers, for example, polymethylmetacrylate, polymethylacrylate, diacetylcellulose, triacetylcellulose, nitrocellulose, polyester, alkyd polymers, and the like.

The hard coat layer 43 has thickness in the range of 0.5 μm to 5 μm, preferably of 0.5 μm to 3 μm. The thickness of the hard coat layer 43 has a large influence on the suitability to the embossing. Namely, when the thickness is too large, the antireflection film becomes unsuitable to embossing. In this case, although the antireflection film is embossed, the front surface cannot have unevenness so as it has been expected. In the antiglare and antireflection film 11 of the embodiment, the small thickness of the hard coat layer 43 is compensated with the primer layer 42 having high surface elasticity. Furthermore, the antiglare and antireflection film 11 may be provided with a moisture barrier, antistatic layer and a protective layer.

Each layer in the antireflection film 11a can be formed in methods of dip coating, air knife coating, curtain coating, roller coating, wire coating, gravure coating, microgravure coating, extrusion coating (U.S. Pat. No. 2,681,294) and the like. In view of that when the smallest amount of solution is cast in wet coating to prevent the unevenness of the dried layer, the methods of microgravure coating and gravure coating are preferable. In view of uniformity of thickness of the layer in a widthwise direction, the method of gravure coating is preferable. Further, more than two solutions may be applied at the same time to form the respective plural layers on the transparent base 41. The methods of applying the coating solutions at the same time are described in U.S. Pat. Nos. 2,761,791, 2,941,898, 3,508,947, 3,526,528, and the publication of: Yuji HARAZAKI, Coating Technology. Asakura-Shoten (1973). P.253.

Further, when it is designated that the antiglare and antireflection film 11 produced in the method of the present invention is used as a protective film on one surface of a polarizing element, then it is necessary to saponify with alkali compounds a surface of the transparent base 41, on which the antireflective layer 13 is not formed. There are two methods of saponification, and one of them is selected.

In the first method, the transparent base 41, after the antireflective layer 13 is formed thereon, is dipped at least once in an alkali solution to make saponification. In the second method, before or after the antireflective layer 13 is formed on a surface of the transparent base 41, the alkali solution is applied on another surface of the transparent base 41, and thereafter, the surface in a side of the antirefrective film is heated, washed with water, and neutralized to make saponification of one of the two surfaces of the film base 41.

A merit of the first method is that saponification is made in the same process as that of the triacetylcellolose film which is polularly used. The demerit of the first method is that each layer in the produced antiglare and antireflection film 11 becomes weaker, as the suponification is made also in the antireflective layer 13. Further, when the solution for saponification remains on the surface, then the surface can be easily stained. The second method is preferable to the first method, although it has not been popular.

When the antiglare and antireflection film 11 is used as the protective film on the one surface of a polarizer, it is preferable to use the polarizer in a liquid crystal display of transmission type, reflection type, semi-transmission type of mode, such as twist nematic (TN), super twist nematic (STN), vertical alignment (VA), in plain switching (IPS), optically compensated bend cell (OCB) and the like. Further, the antiglare and antireflection film 11 is often used in combination with optical compensation films (such as a wide view film), an optical retardation filter, and the like. Further, in a liquid crystal display of transmission type or semi-transmission type, the polarizer is used in combination with a marketed brightness enchancement film (polarizing separation film having a selective layer of polarized light, for example, D-BEF, produced by Sumitomo 3M). In this case, the display having high visibility can be obtained.

Further, when combined with a λ/4 plate, the antiglare and antireflection film 11 (or polarizing element) is used as a protective film for protecting a surface of an organic EL display in order to decrease the reflections on and inside of the surface. Further, in the present invention, when the antireflective layer may be formed on a transparent base made of PET, PEN and the like, then the antiglare and antireflection film 11 is applied to a plasma display panel (PDP), cathode ray tube display (CRT), and the like.

[Experiment]

The following experiment was made according to the present invention. However, the invention was not restricted in the experiment.

(Preparation of Coating Solution A for Primer Layer)

200 pts.wt. of methyl methacrylate whose averaged molecular weight was 25,000 was dissolved in a mixture solvent in which 480 pts.wt. of methylethylketone and 320 pts.wt. of cyclohexanone were mixed. Then, an obtained solution was filtrated by a polypropyrene filter (PPE-03) having porosities. Diameter of each pore was 3 μm. Thus the filtrated solution was obtained as the coating solution A.

(Preparation of Coating Solution B for Primer Layer)

100 pts.wt. of acrylmethacrylate-methacrylic acid copolymer, whose averaged molecular weight was 44,000, was dissolved in a solvent of 900 pts.wt. of methylisobutylketone. Then, an obtained solution was filtrated by the polypropyrene filter (PPE-03) having porosities. Diameter of each pore was 3 μm. Thus the filtrated solution was obtained as the coating solution B.

(Preparation of Coating Solution C for Primer Layer)

100 pts.wt. of methyl methacrylate whose averaged molecular weight was 25,000, and 100 pts.wt. of urethaneacrylate (Shikoh UV-6300B, trade name, produced by Nippon Synthetic Chemical Industry Co., Ltd.) were dissolved in a mixture solvent in which 480 pts.wt. of methylethylketone and 320 pts.wt. of cyclohexanone were mixed. Then, 3 pts.wt. of a photopolymerization initiator for, Irgacure 907 (trade name, produced by Ciba Geigy Japan Limited), was added as a polymerization initiator to an obtained solution. Then the solution was agitated so as to dissolve the photopolymerization initiator, and filtrated by the polypropyrene filter (PPE-03) having porosities. Diameter of each pore was 3 μm. Thus the filtrated solution was obtained as the coating solution C.

(Preparation of Coating Solution D for Hard Coat Layer)

306 pts.wt. of a marketed mixture (DPHA, trade name, produced by Nippon Kayaku Co., Ltd.) of dipentaerythrithol pentaacrylate and dipentaerythrithol hexaacrylate was dissolved in a mixture solvent in which 16 pts.wt. of methylethylketone and 220 pts.wt. of cyclohexanone were mixed. Then, 7.5 pts.wt. of a photopolymerization initiator, Irgacure 907 (trade name, produced by Ciba Geigy Japan Limited), was added as a polymerization initiator to an obtained solution. Then the solution was agitated so as to dissolve the photopolymerization initiator. Thereafter, 450 pts.wt. of a dispersion of SiO₂ (MEK-ST, trade name, produced by Nissan Chemical Industries Ltd.), in which gel-like SiO₂ spheres were dispersed at 30 wt. % of concentration in a methylethylketone, was added to the solution. This solution was agitated and filtrated by the polypropyrene filter (PPE-03) having porosities. Diameter of each pore was 3 μm. Thus the filtrated solution was obtained as the coating solution D.

(Preparation of Dispersion of Titanium Dioxide)

In order to prepare a dispersion of titanium dioxide, the following materials were mixed: 250g of titanium dioxide powder (TTO-55B, trade name, produced by Ishihara Sangyo Kaisha Ltd.), 37.5 g of anionic polyer P1 containing crosslinkable group, 2.5 g of cationic monomer (DMAEA, trade name, produced by Kohjin Co., Ltd.), and 710 g of cyclohexanone. They were dispersed with a mill (DYNO-Mill, trade name, produced by WA Bachofen AG) to obtain the dispersion of titanium dioxide having averaged diameter of 65 nm.

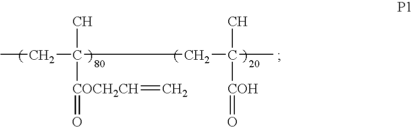

(Preparation of Coating Solution E for Middle Refractive Index Layer)

1.1 pts.wt. of the photopolymerization initiator (Irgacure 907) and 0.4 pts.wt. of a photosensitizer (KAYACURE DETX, produced by NIPPON KAYAKU CO., LTD.) were added to 750 pts.wt. of cyclohexanone and 190 pts.wt. of methylethylketone. Further, 31 pts.wt. of the dispersion of titanium dioxide, and 21 pts.wt. of the marketed mixture (DPHA) of dipentaerythrithol pentaacrylate and dipentaerythrithol hexaacrylate were added to the mixture. Then the mixture was agitated in a room temperature for 30 minutes, and filtrated by the polypropyrene filter (PPE-03) having porosities. Diameter of each pore was 3 μm. Thus the filtrated solution was obtained as the coating solution E for the middle refractive index layer 55.

(Preparation of Coating Solution F for High Refractive index Layer)

1.3 pts.wt. of the photopolymerization initiator (Irgacure 907) and 0.4 pts.wt. of a photosensitizer (KAYACURE DETX, produced by NIPPON KAYAKU CO., LTD.) were added to 540 pts.wt. of cyclohexanone and 180 pts.wt. of methylethylketone. To this mixture was further added 264 pts.wt. of the dispersion of titanium dioxide and 16 pts.wt. of the marketed mixture (DPHA) which contains dipentaerythrithol pentaacrylate and dipentaerythrithol hexaacrylate. Thereafter, the mixture was agitated in a room temperature for 30 minutes, and filtrated by the polypropyrene filter (PPE-03) having porosities. Diameter of each pore was 3 μm. Thus the filtrated solution was obtained as the coating solution F for the high refractive index layer 50.

(Preparation of Coating Solution G for Low Refractive Index Layer)

A copolymer material PF1 which contains fluorine was previously produced, and then the copolymer material PF1 was dissolved in methyisobutylketone to obtain a copolymer solution containing 18.4 wt. % of the copolymer material PF1. Further, 1.7 pts.wt. of the photopolymerization initiator (Irgacure 907) and 1.7 pts.wt. of a reactive silicone (X-22-164, trade name, produced by Shin-Etsu Chemical Co., Ltd.) were added to 193 pts.wt. of cyclohexanone and 623 pts.wt. of methylethylketone. Then, 182 pts.wt. of the copolymer solution was added to the mixture. Thereafter, the solution was agitated and filtrated by the polypropyrene filter (PPE-03) having porosities. Diameter of each pore was 3 μm. Thus the filtrated solution was obtained as the coating solution G for the low refractive index layer 44.

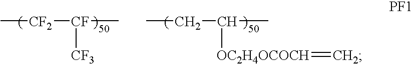

A process of producing the copolymer material PF1 is explained, now. Ethyl acetate at 40 ml, hydroxyethylvinylether (monomer) at 14.7 g and dilauroyl peroxide at 0.55 g were mixed in an autoclave with an agitator made of stainless, whose capacity was 100 ml. Air or gas in the autoclave was fed out, and nitrogen gas was supplied therein instead of the air or the gas. Further, hexafluoropropylene (HFP) at 25 g was supplied in the autoclave, and the temperature of the content in the autoclave becomes 65° C. Thereby the pressure in the autoclave was 5.4×10⁵ Pa. This temperature was maintained to continuously perform chemical reaction for 8 hours. When the pressure became 3.2×10⁵ Pa, the heating of the content was stopped and it was cooled down. When the temperature decreased to the room temperature, then the remaining monomer which had not made reaction was removed. Then the autoclave was opened to obtain a polymer solution.

The polymer solution is added to excess amount of hexane, and the solvent thereof was removed by decantation to obtain a precipitated polymer. This polymer was dissolved in a small amount of ethyl acetate, and the precipitation of the polymer was further made twice, to remove all of the remaining monomer. Thereafter, the polymer was dried. The mass thereof was 28 g. Then the dried polymer at 20 g was dissolved to N,N-dimethylacetamide 100 ml, and this solution was cooled with ice. Thereby, acrylic acid chloride of 11.4 g was dipped to the produced solution, and the produced solution was agitated at the room temperature for 10 hours. Then, ethyl acetate was added to the solution, and thereafter the precipitation is made in the solution to obtain the copolymer PF1 containing fluorine. The copolymer PF1 had a number-averaged molecular weight of 31,000, and a refractive index of 1.421.

(Preparation of Coating Solution H for Low Refractive Index Layer)

A copolymer material PF2 which contained fluorine was previously produced, and then the copolymer PF2 was dissolved in methyisobutylketone to obtain a copolymer solution containing 18.4 wt. % of the copolymer PF2. Further, 3.4 pts.wt. of the photopolymerization initiator (UVI16990, trade name, produced by Union Carbide Corporation) and 3.4 pts.wt. of the reactive silicone (X-22-164) were added to 193 pts.wt. of cyclohexanone and 623 pts.wt. of methylethylketone. Then, 182 pts.wt. of the copolymer solution was added to this mixture. Thereafter, the copolymer solution was agitated and filtrated by the polypropyrene filter (PPE-03) having porosities. Diameter of each pore was 3 μm. Thus the filtrated solution was obtained as the coating solution G for the low refractive index layer H.

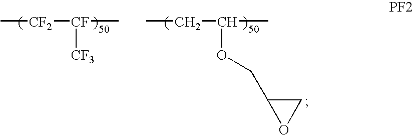

A process of producing the copolymer PF2 was explained. Ethyl acetate at 30 ml, glycidylvinylether (monomer) at 11.5 g and dilauroyl peroxide at 0.42g were mixed in an autoclave with an agitator made of stainless, whose capacity was 100 ml. Air or gas in the autoclave was fed out, and nitrogen gas was supplied therein instead of the air or the gas. Further, hexafluoropropylene (HFP) at 21 g was supplied in the autoclave, and the temperature of the content in the autoclave becomes 65° C . Thereby the pressure in the autoclave was 6.2×10⁵ Pa. This temperature was maintained to continuously perform chemical reaction for 8 hours. When the pressure became 3.6×10⁵ Pa, the heating of the content was stopped and it was cooled down.

When the temperature decreased to the room temperature, then the remaining monomer which had not made reaction was removed to obtain a polymer solution. Then, the polymer solution is added in excess amount of hexane, and the solvent thereof was removed by decantation to obtain a precipitated polymer. This polymer was dissolved in a small amount of ethyl acetate, and the precipitation of the polymer was further made twice, to remove all of the remaining monomer. Thereafter, the polymer was dried and obtained as the copolymer PF2 containing fluorine. The mass thereof was 21 g. The copolymer PF2 has a number-averaged molecular weight of 28,000, and a refractive index of 1.424.

(Production of Antireflection Film Having Antireflective Layer)

A first gravure coater cast the coating solution A for the primer layer to coat a cellulosetriacetate film (TAC-TD80U, trade name, produced by Fuji Photo Film Co., Ltd.) whose thickness was 80 μm. Then the coating solution A was dried at 100° C. for two minutes so as to form the primer layer 42. Note that a surface elasticity of the cellulosetriacetate film was 3.9 GPa at the room temperature (25° C.), and 2.3 Gpa at 120° C. Further, the primer layer 42 had the refractive index of 1.49 and thickness of 8 μm. The surface elasticity of the primer layer was 4.2 GPa at the room temperature (25° C), and 0.9 GPa at 120° C.

Thereafter, a second gravure coater cast the coating solution D for the hard coat layer over the primer layer 42. The coating solution D was dried at 100° C. for two minutes, and then the UV-ray was irradiated onto the coating solution D such that the curing might be made in the coating solution D. Thus the hard coat layer 43 was formed, which had the refractive index of 1.51 and thickness of 2 μm. The surface elasticity of the primer layer was 8.9 GPa at the room temperature (25° C.), and 7.7 GPa at 120° C.

Further, a third gravure coater cast the coating solution E for the middle refractive index layer 55 over the hard coat layer 43. After the coating solution E was dried at 100° C., the UV-ray was irradiated onto the coating solution E such that the curing might be made in the coating solution E. Thus the middle refractive index layer 55 was formed, which had the refractive index of 1.63 and thickness of 67 nm.

A forth gravure coater cast the coating solution F for the high refractive index layer 50 over the middle refractive index layer 55. After the coating solution F was dried at 100° C., the UV-ray was irradiated onto the coating solution F such that the curing might be made in the coating solution F. Thus the high refractive index layer 50 was formed, which had the refractive index of 1.90 and thickness of 107 nm.

A fifth gravure coater cast the coating solution G for the low refractive index layer 44 over the high refractive index layer 50. After the coating solution G was dried at 100° C., the UV-ray was irradiated onto the coating solution G such that the curing might be made in the coating solution G. Thus the low refractive index layer 44 was formed, which had the refractive index of 1.43 and thickness of 86 nm, and the antireflection film 11a having antireflective layer was obtained.

### EXAMPLE 1(1)

An embossing machine used in Example 1-1 was produced by Toyo Seiki Co., Ltd. The embossing machine has the emboss plate 21 and the back-up plate 22 for performing plate embossing. The back-up plate 22 was made of SUS 630. The emboss plate 21 has a base of SUS 630 whose size was 10×50×50 mm. One of surfaces of the base, whose size was 50×50 mm, was plated with nickel at thickness of 100 μm. The balls 32 were made of glass and shot at pressure of 2.5×10⁵ Pa onto the plated one surface, so as to form the concave-convex while the balls 32 each have a diameter of maximum 20 μm and apparent specific gravity of 1.5-1.6 kg/L. After set of the antireflection film 11a to the embossing machine, plate embossing was performed with a pressure of 400×10⁵ Pa for 120 seconds to obtain the antiglare and antireflection film 11 with antiglare property. Thereby, the temperature of the emboss plate 21 was 165° C., and that of the back-up plate was the room temperature.

Then, the front surface of the antiglare and antireflection film 11 was estimated with eyes. Roughness was not observed and the front surface made good impressions for the products. Further, in each layer, thickness was almost uniform and fluctuates in the range of +1% to −1% to the average of the thickness.

Furthermore, the following estimations were made according to the obtained antiglare and antireflection film 11 with antiglare property. The results of the estimations are illustrated in Table 1.

(1) Specular Reflectance

A spectrophotometer V-550 (produced by JASCO Corporation) was provided with an adapter ARV-474 to measure the specular reflectance at an exiting angle of −5° according to the incident light of wavelength in the range of 380 nm to 780 nm at the incident angle of 5°. Then the average of the specular reflectance of the reflection whose wave length was in the range of 450 nm to 650 nm was calculated to evaluate antiglare property.

(2) Arithmetic Roughness Average (Ra) and Average Period of Concave-convex (RSm)

These values were measured with SJ-401, produced by Mitsutoyo Corporation, according to the front surface of the antiglare and antireflection film 11 with antiglare property.

(3) Surface Elasticity

The surface elasticity was measured by the microhardness testing tystem, Fischerscope H100VP-HCU (trade mark, produced by Fischer Instruments K. K.)

(4) Pencil Hardness (PH)

The pencil hardness represents a grade of scratch resistance. The evaluations of pencil hardness was made as described in JIS-K-5400. After the antiglare and antireflection film 11 was set in atmosphere with the temperature of 25° C. and the humidity of 60% RH for two hours, the front surface of the antiglare and antireflection film 11 was scratched with H-5H test pencils determined in JIS-S-6006. Thereby a force of 500 g was applied to the test pencil. This test was made five times. The evaluation of the pencil hardness was “E” (Excellent), when no scratch remains on the front surface in the five tests. The evaluation was “R” (Reject) when more than three scratches remain on the front surface in the five tests.

(5) Contact Angle

The contact angle represents a grade of stainproofness, especially finger printing stainproofness. After the antiglare and antireflection film 11 was set in the atmosphere with the temperature of 25° C. and the humidity of 60% RH for two hours, the contact angle to pure water on the antiglare and antireflection film 11 was measured.

(6) Coefficient of Dynamic Friction

The coefficient of dynamic friction represents the grade of the smoothness of the front surface of the antiglare and antireflection film 11. After the antiglare and antireflection film 11 was set in the atmosphere with the temperature of 25° C. and the relative humidity of 60% for two hours, the coefficient of dynamic friction was measured with a machine for measuring the coefficient of dynamic friction, HEIDON-14, in which a stainless ball of φ5 mm was used. Thereby, the speed was set to 60 cm/min, and a force of 100 g was applied on the front surface of the antiglare and antireflection film 11.

(7) Dazzling (Da)

The produced antiglare and antireflection film 11 was set at 1 mm apart from a cell of 200 ppi (200 pixels/inch) to estimate with eyes the dazzling, the nonuniformity of brightness, which was caused by projections on the front surface of the antiglare and antireflection film 11. The estimation was “E” (Excellent), when no dazzling occurred. The estimation was “G” (Good), when the dazzling did not almost occur. The estimation was “R” (Reject) when the dazzling occurred to make the impression of the formed image worse.

(8) Antiglare Property (AG)

An illumination lamp (8000 cd/m²) without louver emitted a light onto the antiglare and antireflection film 11 and the light reflected. Thereby, an image of the illumination lamp on the front surface of the antiglare and antireflection film 11 was observed with eyes. The estimation of antiglare property was “E” (Excellent) when no outline of the illumination lamp was observed. The estimation was “G” (Good) when the outline was slightly recognized. The estimation was “R” (Reject) when the outline was almost clear.

### EXAMPLE 1(2)

The balls 32 used for forming the concave-convex had a diameter of maximum 30 μm and apparent specific gravity of 1.5-1.6 kg/L. Other conditions were the same as in Example 1-1. The front surface of the obtained antiglare and antireflection film 11 was estimated with eyes. Roughness was not observed and the front surface made good impressions for the products. Further, in each layer, thickness was almost uniform and fluctuates in the range of +1% to −1% to the average of the thickness.

### EXAMPLE 1(3)

The balls 32 used for forming the concave-convex had a diameter of maximum 50 μm and apparent specific gravity of 1.5-1.6 kg/L. Other conditions were the same as in Example 1(1). The front surface of the obtained antiglare and antireflection film 11 was estimated with eyes. Roughness was not observed and the front surface made good impressions for the products. Further, in each layer, thickness was almost uniform and fluctuates in the range of +1% to −1% to the average of the thickness.

Further, the above estimations (1)-(8) were made the same as in Example 1(1). Table 1 illustrates the results of estimations in Examples 1(1)-(3).

TABLE 1

| | Diameter of | Ra | RSm | Average | | | |
|---|---|---|---|---|---|---|---|
| | balls (μm) | (μm) | (μm) | Reflectivity | PH | Da | AG |
| Ex. 1(1) | Maximum 20 | 0.102 | 18.1 | 0.28 | 3H | E | E |
| Ex. 1(2) | Maximum 30 | 0.131 | 22.5 | 0.29 | 3H | G | E |
| Ex. 1(3) | Maximum 50 | 0.384 | 36.9 | 0.28 | 3H | E | R |

According to the estimation of dazzling and antiglare property for Example 1(1), the antiglare and antireflection film 11 has low reflectivity and especially preferable reflection characteristics. Further, the antiglare and antireflection film 11 was hardly damaged, as the coefficient of dynamic friction was 0.15, namely low. As the contact angle to pure water was about 100°, the water- and oil-repelling properties were high, and the stainproofness was large. Furthermore, the scratch resistance was large, as the pencil hardness was 3H, namely large. Therefore the quality of the antiglare and antireflection film 11 in Example 1(1) was high. In Examples 1(2) and 1(3), the average period RSm of recess and projection was too large, and as the dazzling was observed, the front surface was rough.

### EXAMPLES 2(1)-2(5)

In Example 2, the antireflection film 11a was embossed with the embossing machine 10 (produced by Yuri Roll Co., Ltd.) to obtain the antiglare and antireflection film 11. The back-up roll 15 was made of S45C, and the surface thereof was plated with hard chrome whose thickness was 100 μm. The emboss roller 14 was made of S45C, and the surface thereof was plated with nickel whose thickness was 100 μm. The balls 32 made of glass had a diameter of maximum 20 μm and apparent specific gravity of 1.5-1.6 kg/L. The balls 32 were shot at pressure of 2.5×10⁵ Pa onto the plated one surface, so as to form the concave-convex. The temperature of preheat was 90° C., embossing speed was set to 0.5 m/min, the temperature of the emboss roller was in the range of 105° C. to 195° C., and the linear pressure was in the range of 500 N/cm to 4000 N/cm. In Examples 2(1)-(5), the estimation of dazzling and antiglare property were made. Table 2 illustrates the results of estimations in Examples 2(1)-(5).

TABLE 2

| | Temperature of | Linear Pressure | | |
|---|---|---|---|---|
| | emboss roller (° C.) | (N/cm) | Da | AG |
| Ex. 2(1) | 165 | 500 | — | R |
| Ex. 2(2) | 165 | 1000 | — | E |
| Ex. 2(3) | 165 | 4000 | E | E |
| Ex. 2(4) | 110 | 2000 | E | G |
| Ex. 2(5) | 195 | 2000 | — | R |

In Example 2(3), as the antiglare and antireflection film 11 has the uniform antiglare property in a widthwise direction and low reflectivity. Further, the antireflection film was hardly damaged, as the coefficient of dynamic friction was 0.15, namely low. As the contact angle to pure water was about 100°, the water- and oil-repelling properties were high, and the stainproofness was large. Furthermore, the scratch resistance was large, as the pencil hardness was 3H, namely large. Therefore the quality of the antireflection film in Example 2(3) was high. In Examples 2(1), the linear pressure was too low and the image was not formed. In Example 2(3), the image had uniformity of brightness in a widthwise direction. In Example 2(4), as the temperature of the emboss roller 14 was too low, the surface elasticity did not became enough low. Accordingly the thickness of each layer was not uniform, and therefore the antiglare and antireflection film 11 had too bad conditions of the surface to have enough effects necessary for the antiglare and antireflection film 11.

### EXAMPLES 3(1)-3(5)

In Examples 3(1)-3(5), the antireflection film 11a was embossed with the same embossing machine as in Example 1(1) to obtain the antiglare and antireflection film 11. The temperature of the emboss plate 21 and the pressure applied for embossing were changed in the range of 105° C. to 195° C., and of 50×10⁵ Pa to 400×10⁵ Pa, respectively. Other conditions were the same as in Example 1. In Examples 3(1)-(5), the estimation of dazzling and antiglare property was made. Table 3 illustrates the results of estimations in Examples 3(1)-(5).

TABLE 3

| | Temperature of | Embossing | | |
|---|---|---|---|---|
| | emboss roller (° C.) | Pressure (Pa) | Da | AG |
| Ex. 3(1) | 165 | 50 × 10⁵ | — | R |
| Ex. 3(2) | 165 | 200 × 10⁵ | E | E |
| Ex. 3(3) | 165 | 400 × 10⁵ | E | E |
| Ex. 3(4) | 105 | 200 × 10⁵ | E | R |
| Ex. 3(5) | 195 | 200 × 10⁵ | — | R |

In Examples 3(2) and 3(3), as the antiglare and antireflection film 11 has the uniform antiglare property in a widthwise direction and low reflectivity. Further, the antiglare and antireflection film 11 was hardly damaged, as the coefficient of dynamic friction was 0.15, namely low. As the contact angle to pure water was about 100°, the water- and oil-repelling properties were high, and the stainproofness was large. Furthermore, the scratch resistance was large, as the pencil hardness was 3H, namely large. Therefore the quality of the antireflection film in Examples 3(2) and 3(3) was high. In Example 3(1), the linear pressure was too low and the image was not formed. In Example 3(4), as the temperature of the emboss roller 14 was too high, the surface elasticity did not became enough low. Accordingly the thickness of each layer was not uniform, and therefore the antireflection film had too bad conditions of the front surface to have effects necessary for the antireflection film.

### EXAMPLE 4

The antireflection film of Example 2(3) was dipped in 2.0 N—NaOH aqueous solution at 55° C. for two minutes to saponify a rear surface of the antireflection film, on which the antireflective layer was not formed. On the other hand, a cellulose triacetate film (TAC-TD80U, trade name, produced by Fuji Photo Film Co., Ltd.) was saponified under the same conditions. Further, iodine was absorbed to a polyvinyl alcohol, and thereafter the polyvinyl alcohol was drawn to become a polarizer. Thereafter, the antireflection film and the cellulose triacetate film were adhered to both surfaces of the polarizer for protecting these surfaces, so as to produce a test polarizing filter. The test polarizing filter can be used in a LCD of a notebook type personal computer having TN liquid crystal display. In the TN liquid crystal display, an original polarizing filter was positioned in a diplay side from a TN liquid crystal cell (or TN cell). In Example 4, the original polarizing filter in the display side was exchanged to the test polarizing filter such that the antireflection film may be disposed in the display side of the polarizing filter. It is to be noted that the LCD had between a backlight and a (TN) liquid crystal cell a polarization separation film, D-BEF (trade name, produced by Sumitomo 3M), which had a selective layer of polarized light. In Example 4, the estimation was made according to the LCD. The external light was not reflected so much, and the quality of displayed images was high.

### EXAMPLE 5

In Example 5, 1.0 N—KOH aqueous solution was cast by a coating bar to coat the rear surface of the antireflection film. Then the temperature of the rear surface was 60° C. for 10 seconds. Thereafter, the rear surface was washed with water and dried. Other conditions were the same as in Example 4. In Example 5, the quality of displayed image was as high as in Example 4.

### EXAMPLE 6

In a backlight side from the liquid crystal cell in Example 5, there was a polarizing filter which included a protective film in a cell side (side of the liquid crystal cell) in the polarizing filter. In Example 6, this protective film was exchanged to the wide view film (Wide View Film SA-12B, trade name, produced by Fuji Photo Film). Further, in Example 5, the test polarizing filter in a display side from the liquid crystal cell included a protective film in the cell side. In Example 6, this protective film was exchanged to the wide view film (Wide View Film SA-12B, trade name, produced by Fuji Photo Film). The wide vies film includes an optical compensation layer in which a disk-shaped surface of a unit constructing discotic structure was inclined to a surface of the transparent base, and in which an angle formed between the respective surfaces of the unit and the transparent base varies in a thickness direction of an optical anisotropic layer. In the LCD in this example, the contrast was excellent in a bright room, the view angle in every direction was extremely wide, and the image could be perceived with extreme easiness. Accordingly, the quality of display was high.

### EXAMPLE 7

The antireflection film in Example 2(3) was adhered with an adhesive agent to a glass plate in a front side of the organic EL display. The reflection on a surface of the glass plate was prevented, and the image could be perceived with extreme easiness.

### EXAMPLE 8

λ/4 filter was adhered to another surface of the test polarizing filter of Example 4 so as to confront to the liquid crystal cell in the LCD. The reflection on the surface of the LCD and the reflection on an inside glass was removed, and the image could be perceived with extreme easiness.

Various changes and modifications are possible in the present invention and may be understood to be within the present invention.

What is claimed is:

1. A method of producing an antiglare and antireflection film from an antireflection film having an antireflective layer, said method comprising:
embossing said antireflective layer of said antireflection film with an emboss press member to obtain said antiglare and antireflection film, a surface of said emboss press member having a large number of concaves or convexes, said surface having arithmetic roughness average in the range of 0.05 μm to 2.00 μm, and said concave or convex having mean profile peak spacing (RSm) of maximum 50 μm.

2. A method as described in claim 1, wherein said concave or convex of said emboss press member is formed in a shot blast method in which balls having diameter in the range of 0.1 μm to 50.0 μm are shot on said surface.

3. A method as described in claim 2, wherein said antireflection film further includes a transparent base, a primer layer and a hard coat layer, and said transparent base is coated with said primer layer, said hard coat layer and said antireflective layer in this order.

4. A method as described in claim 3, wherein said antireflective layer includes a low refractive index layer.

5. A method as described in claim 4, wherein said antireflective layer further includes a high refractive index layer formed on said low refractive index layer.

6. A method as described in claim 5, wherein said antireflective layer further includes a middle refractive index layer between said low refractive index layer and said high refractive index layer.

7. A method as described in claim 6, wherein said base is formed of cellulose triacetate, said hard coat layer is formed of dipentaerythrithol pentaacrylate and dipentaerythrithol hexaacrylate, said low refractive index layer is formed of copolymer material PF1, and said middle and high refractive index layers are formed of dipentaerythrithol pentaacrylate, dipentaerythrithol hexaacrylate and dispersion of titanium dioxide.

8. A method as described in claim 7, wherein the thickness of said base, said hard coat layer, said low refractive index layer, said middle refractive index layer and said high refractive index layer have respective thickness of 80 μm, 2 μm, 86 nm, 67 nm and 107 nm.

9. A method as described in claim 3, wherein said emboss press member is an emboss press plate which is positioned in an emboss station, and said antireflection film is transported intermittently toward said emboss station.

10. A method as described in claim 9, wherein, when said antireflection film is embossed, then a temperature of said antireflection film is in the range of 110° C. to 195° C., and said emboss press plate presses said antireflection film with a pressure in the range of 50×10⁵ Pa to 400×10⁵ Pa.

11. A method as described in claim 3, wherein said emboss press member is an emboss press roller which is positioned in an emboss station, and said antireflection film is transported continuously toward said emboss station.

12. A method as described in claim 11, wherein, when said antireflection film is embossed, a temperature of said antireflection film is in the range of 110° C. to 195° C. and said emboss roller presses said antireflection film a linear pressure from 500 N/cm to 4000 N/cm.
